(19) United States
(12) Patent Application Publication
(10) Pub. No.: US 2006/0071453 A1
(43) Pub. Date: Apr. 6, 2006

(54) Ventilated strollers and methods of ventilating strollers

(76) Inventors: Peter J. Myers, Wheaton, IL (US); Thomas N. Koltun, Chicago, IL (US)

Correspondence Address: GROSSMAN & FLIGHT LLC;Suite 4220, 20 North Wacker Drive, Chicago, IL, 60606-6357, US

(21) Appl. No.: 10/956,652

(22) Filed: Oct. 1, 2004

(51) Int. Cl. B62B 7/00

(52) U.S. Cl. 280/652

(57) ABSTRACT

Ventilated strollers and methods of ventilating strollers are disclosed. An example stroller includes a wheeled frame, a seat coupled to the frame, and a cover to selectively cover a mesh panel of the seat.

### FIELD OF THE DISCLOSURE

This disclosure relates generally to strollers for infants and children, and, more particularly, to ventilated strollers and methods of ventilating strollers.

### BACKGROUND

Strollers are commonly used by parents to transport infants and small children. Typically, strollers include a wheeled frame, a handle and a seat to receive a stroller occupant. The seat typically includes a seat bottom, side supports and/or a back support. For foldable strollers such as umbrella strollers, the seat bottom, the side supports and/or the back support are constructed of sufficiently strong, flexible materials to allow the stroller to be collapsed into a smaller size when not in use.

Strollers are used in a variety of climate conditions, varying from hot to cold temperatures, pleasant to inclement weather, etc. As such, it is desirable to provide protection from weather elements for the stroller occupant. Such protection is commonly provided by a canopy which may be extended or retracted above the seat of the stroller.

### BRIEF DESCRIPTION OF THE DRAWINGS

FIG. 1 is a perspective view of an example stroller having a seat back containing a mesh panel and a cover shown in a first example position.

FIG. 2 is a view similar to FIG. 1, but showing the cover in a second example position.

FIG. 3 is a view similar to FIGS. 1 and 2, but showing the cover in a third example position.

FIG. 4 is a cross-sectional side view of the seat of FIGS. 1-3, showing the cover in the third example position.

### DETAILED DESCRIPTION

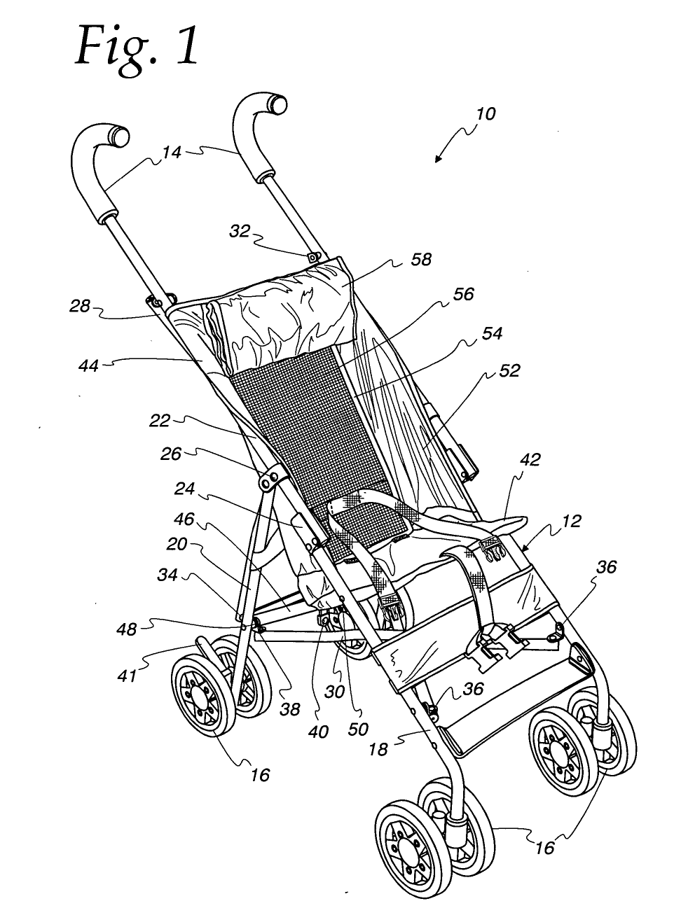

FIG. 1 is a perspective view of an example stroller 10 constructed in accordance with the teachings of the invention. Persons of ordinary skill in the art will appreciate that, although the following description and drawings illustrate a stroller of the type commonly referred to in the art as an umbrella stroller, the teachings of the invention are in no way limited to any particular type of stroller. On the contrary, the teachings of the invention may be employed with any type of stroller, be it an umbrella stroller, a conventional stroller, a double stroller, a pram, a foldable stroller, a non-foldable stroller, or any other type of stroller.

The example stroller 10 of FIG. 1 includes a wheeled frame 12 having a pair of handles 14. In the illustrated example, the wheeled frame 12 includes a pair of front legs 18 and a pair of rear legs 20. The illustrated stroller 10 includes eight wheels 16, two on each of the front legs 18 and two on each of the rear legs 20. However, persons of ordinary skill in the art will appreciate that other numbers of wheels 16 and/or other numbers of legs 18, 20 could alternatively be employed. For example, although the illustrated frame 12 includes four legs 18, 20, persons of ordinary skill in the art will readily appreciate that three legs might be preferred if, for instance, the stroller 10 is intended for use as a jogging stroller. In such an application, the stroller would typically be provided with three wheels or tires, with each wheel or tire rotatably carried by a respective one of the three legs.

The example wheeled frame 12 also includes upper support arms 22, each of which terminates in a respective one of the handles 14. Hinged couplings 24 respectively couple a corresponding one of the upper support arms 22 with a respective one of the front legs 18. Additionally, hinged couplings 26 respectively couple a corresponding one of the upper support arms 22 with a respective one of the rear legs 20.

To provide lateral support between the opposite sides of the frame 12, the wheeled frame 12 includes two posterior lateral support arms 28 and two bottom lateral support arms 30. The posterior lateral support arms 28 are crossed with respect to one another. Similarly, the bottom lateral support arms 30 are crossed with respect to one another. Hinged couplings 32 respectively couple a corresponding one of the posterior lateral support arms 28 to a respective one of the upper support arms 22. Similarly, hinged couplings 34 respectively couple a corresponding one of the posterior lateral support arms 28 to a respective one of the rear legs 20. Hinged couplings 36 respectively couple a corresponding one of the bottom lateral support arms 30 with respective ones of the front legs 18. Additionally, hinged couplings 38 respectively couple a corresponding one of the bottom lateral support arms 30 with respective ones of the rear legs 20. Although not shown, conventional pivotable couplings are used to couple the posterior lateral support arms 28 to one another and/or couple the bottom lateral support arms 30 to one another to further reinforce the structural integrity of the wheeled frame 12.

In the illustrated example, seat support arms 46 are pivotably coupled to respective ones of the legs 18, 20 of the frame 12. Each of the seat arms 46 projects at an upward and forward angle from the front legs 18. Hinged couplings 48 respectively couple a corresponding one of the seat support arms 46 to a respective one of the rear legs 20. Additionally, hinged couplings 50 respectively couple a corresponding one of the seat support arms 46 to a respective one of the front legs 18.

The hinged couplings 24, 26, 32, 34, 36, 38, 48 and 50 enable the wheeled frame 12 to be collapsed for convenient storage and/or transport when the stroller 10 is not in use. To secure the hinged couplings 24, 26, 32, 34, 36, 38, 48 and 50 when the stroller 10 is in use, the wheeled frame 12 includes a conventional locking mechanism 40. The example locking mechanism 40 shown in the drawings includes a pair of pivotable arms that may be locked in an extended position, thereby securing the hinged couplings 24, 26, 32, 34, 36, 38, 48, and 50 to prevent the wheeled frame 12 from collapsing.

The illustrated example stroller 10 includes a brake 41 to substantially secure one of the rear wheels of the stroller 10 against rolling movement. Although not shown in the figures, the stroller 10 preferably includes a second brake which is identical to the first brake 41, but positioned to secure the rear wheels 16 on the opposite side of the stroller against rolling movement.

The illustrated example stroller 10 also includes a conventional footrest positioned between the front legs 18. The footrest may be implemented by, for example, a pliable strap.

Although not shown in the illustrated example, persons of ordinary skill in the art will appreciate that the stroller 10 of FIG. 1 may be equipped with other conventional stroller features. For example, a tray for food, drinks and/or toys might be positioned on the wheeled frame 12 for use by a seated child, and/or a parent tray might be mounted to the upper support arms 22 or the handles 14 in a position to support drinks, food, and/or other objects within easy reach of a standing adult pushing the stroller 10. The stroller 10 may also include a conventional, pivotable canopy to protect a child carried in the stroller from direct sunlight or inclement weather. Further, the stroller 10 may include a basket carried by the frame 12 (e.g., suspended from the upper support arms 22 and/or beneath the seat).

In the illustrated example, the wheeled frame 12 supports a seat for carrying a child and a child restraint (e.g., a seat belt) to secure the child in the seat. The illustrated seat includes a seat bottom 42 and a seat back 44. The seat is coupled to, and supported by, the upper support arms 22 and the seat support arms 46.

The seat bottom 42 and the seat back 44 may be integrally formed or separate. Furthermore, the seat bottom 42 and/or the seat back 44 may be permanently coupled or detachably coupled to the frame 12. For some applications, a permanent coupling may be desired, whereas for other applications, a detachable coupling may be desired (e.g., to facilitate cleaning of the seat).

The illustrated seat back 44 includes side supports 52 and a back support 54. The back support 54 includes a mesh panel 56 to provide ventilation. To allow the stroller 10 to be collapsed when not in use, the seat bottom 42 and/or the back 44 may be constructed from a flexible material, such as a cotton fabric, a polyester fabric, nylon, vinyl, etc., or from any combination thereof. The mesh panel 56 may be implemented by a fine-pitch or coarse-pitch mesh having any orientation, such as a horizontal/vertical weave, an angular weave, a patterned weave, etc. Additionally, the mesh panel 56 may be integrally formed in the back support 54, or the panel 56 and the remainder of the back support 54 may be separate structures joined together by, for example, sewing, bonding, etc.

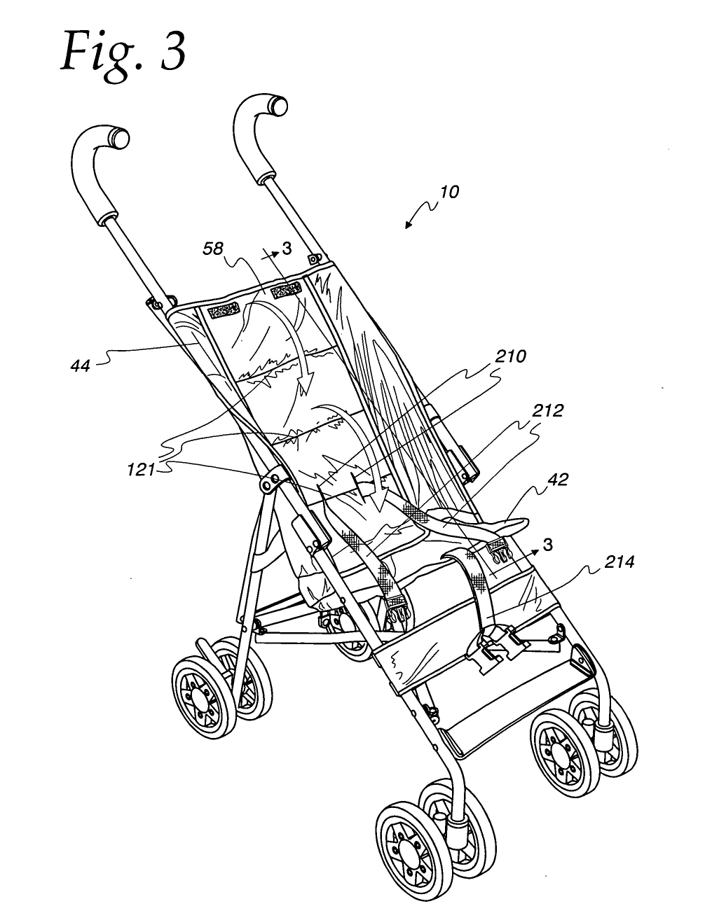

To selectively expose or occlude the mesh panel 56 and, thus, to permit or prevent ventilation of the seat through the mesh panel 56, the illustrated example stroller includes a cover 58. The cover 58 may be positioned in a closed position (illustratively, the example position shown in FIG. 3) wherein the mesh panel 56 is completely covered, or in an opened position (illustratively, the example position shown in FIG. 1) wherein the mesh panel 56 is at least partially exposed to provide ventilation through the seat back 54 of the stroller 10. Persons of ordinary skill in the art will appreciate that positions other than the opened and/or closed positions shown in the figures may be provided for the cover 58. For example, an opened position in which the cover 58 is completely removed from the seat and/or frame 12 is possible. As another example, an opened position in which the cover 58 remains coupled to the seat and/or frame 12, but is positioned behind the seat back 54 (e.g., hanging freely, folded or rolled) is also possible. Similarly, although in the illustrated example, the cover 58 is positioned in front of the mesh panel 56 when the cover is in the closed position, a closed position in which the cover 58 is located behind the mesh panel 56 would also be appropriate. Further, although in the illustrated example, the cover 58 is permanently secured above the mesh panel 56, permanently securing the cover 58 below the mesh panel 56 would also be appropriate.

The cover 58 may be integrally coupled to the seat back 54. Alternatively, the cover 58 may be coupled directly to the frame 12 (e.g., removably or permanently), or detachably coupled to the seat back 54.

In the illustrated example, the cover 58 may be rolled or folded from the closed position into the opened position. When so folded, the cover 58 extends outwardly from the front surface of the seat back 54 to form a headrest for use by a child seated in the stroller 10 as shown in FIG. 1. Alternatively, the cover 58 may be wrapped over the top of the seat back to move the cover 58 from the closed position to the opened position.

To releasably secure the cover 58 in the opened position of FIG. 1, the illustrated cover 58 is provided with releasable fasteners. In the illustrated example, the releasable fasteners are implemented by hook and loop fasteners 110, 112 such as VELCRO.™ However, persons of ordinary skill in the art will appreciate that any other known fastener may be used in this role. For example, the fasteners may be implemented by snaps, buttons, zippers, releasable glue, ties, etc. or, alternatively, there may be no fastener at all such that the cover hangs freely.

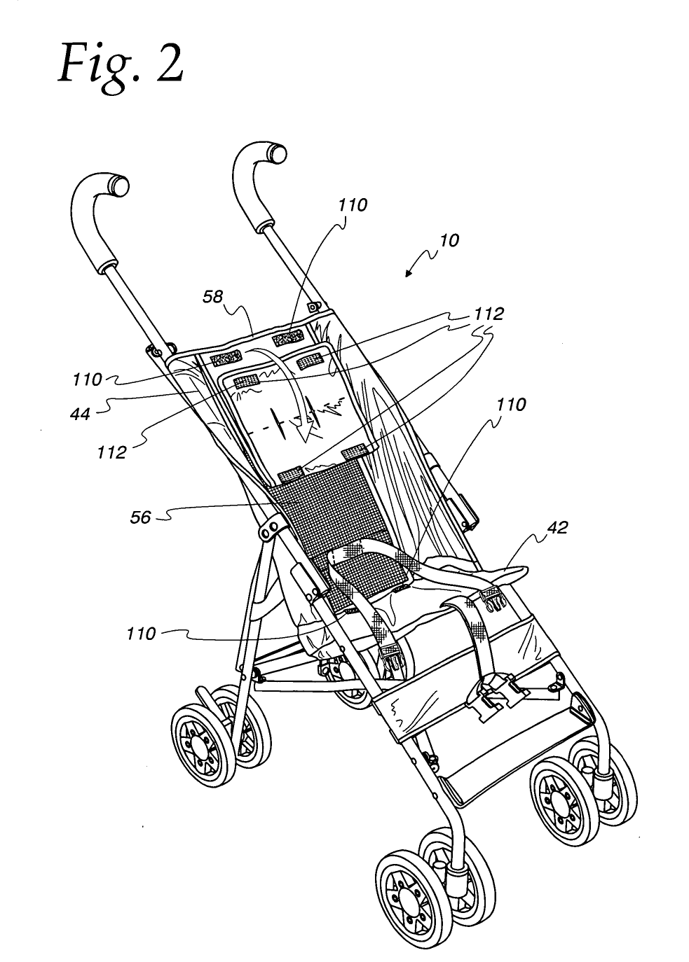

In the illustrated example, two hook and loop fasteners 110 are located on the front of the cover 58, four hook and loop fasteners 112 are located on the back of the cover 58 (see FIG. 2), and two hook and loop fasteners are located on the seat bottom 42. In the illustrated example, the hook and loop fasteners 112 on the back of the cover 58 are of the same type, and the hook and loop fasteners 110 on the front of the cover 58 and the seat bottom 42 are of the same type. A first two of the hook and loop fasteners 112 on the back of the cover 58 are structured to couple with corresponding ones of the hook and loop fasteners 110 on the seat bottom 42 to secure the cover 58 in the closed position of FIG. 3. The second two of the hook and loop fasteners 112 on the back of the cover 58 are structured to couple with corresponding ones of the hook and loop fasteners 110 on the front of the cover 58 to secure the cover 58 in the opened position of FIG. 1 (e.g., in the headrest configuration).

To facilitate securement of the cover 58 in the opened position of FIG. 1, the cover 58 is divided into four, substantially equal sections by three seams 121 which are equally spaced from one another (see FIG. 3). In the illustrated example, the seams 121 are implemented by stitching. The fasteners 110, 112 are positioned such that, folding the cover 58 about the seams 121 results in respective ones of the fasteners 112 aligning with the fasteners 110 on the front of the cover 58 to hold the cover 58 in the opened position shown in FIG. 1. As mentioned above, the folded or rolled cover 58 functions as a headrest in this position.

Persons of ordinary skill in the art will appreciate that, although the illustrated example employs four pairs of fasteners 110, 112, any other number of fasteners may alternatively be employed (e.g., one fastener, two fasteners, three fasteners, five fasteners, etc.). Further, although the illustrated example divides the cover into four substantially equal sections, any number of equal or unequal sections (including none) can be employed. Similarly, any number of folds (including none) to move the cover 58 from the closed position to the opened position.

To ensure that the cover 58 does not interfere with the operation of the child restraint 212, the cover 58 is provided with openings 210. As shown in FIG. 3, the openings 210 of the illustrated stroller 10 are sized and positioned to receive respective straps of the child restraint 212 when the cover 58 is placed in the closed position. In the illustrated example, the straps passing through the cover 58 form a waist belt which may be fastened to a crotch strap 214 to secure a child in the seat of the stroller 10 in a conventional fashion. Although the illustrated cover 58 includes the openings 58, persons of ordinary skill in the art will appreciate that the openings may be omitted and/or other locations, shapes, and/or sizes of openings may be employed to suit the type of child restraint employed with the stroller. For example, the openings can be eliminated and the cover may be shortened to not overlap the restraint.

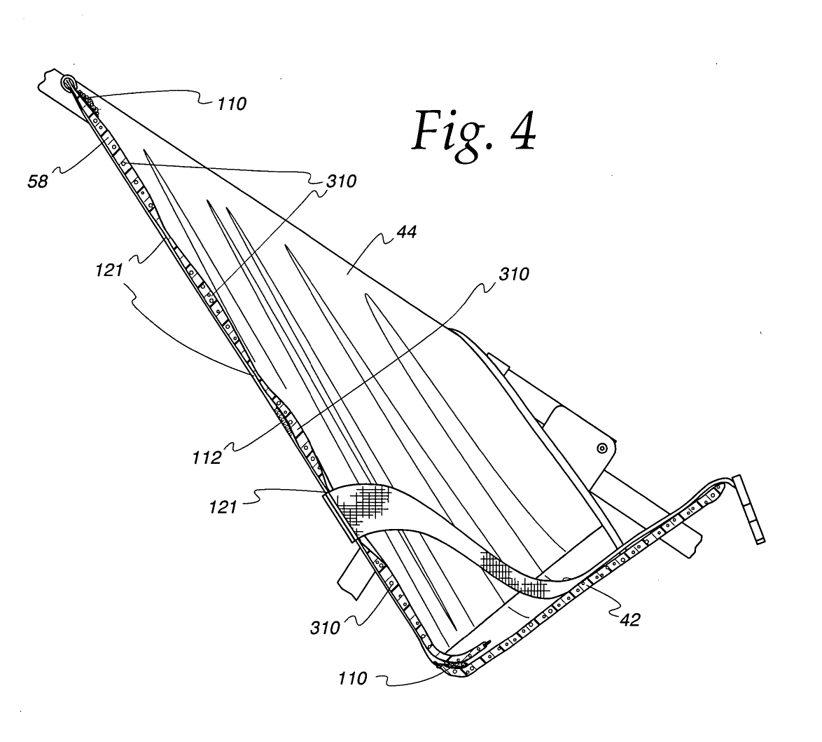

A side view of the example seat bottom 42, the example seat back 54 and the example cover 58 of FIGS. 1-3 is shown in FIG. 4. As shown in FIG. 4, the cover 58 of the illustrated example comprises a front face and a rear face sewn together to capture padding 310 therebetween. As shown in FIG. 4, the seams 121 divide the padding 310 into four substantially equal areas to facilitate folding of the cover 58 and to ensure the padding 310 remains distributed within the cover 58 in a substantially even manner. The padding 310 provides a comfortable support for the back of a child seated in the stroller 10 when the cover 58 is in the closed position, and a comfortable headrest for the child when the cover 58 is folded or rolled into the opened position shown in FIG. 1.

In use, the stroller may be ventilated by moving a cover from a closed position to an opened position to expose at least a portion of a mesh area in a seat. The cover may then be secured in the opened position. Moving the cover may include folding or rolling the cover to shape the cover into a headrest. Moving the cover may also include removing a child restraint from an opening in the cover.

The amount of ventilation of the stroller may be reduced by releasing the cover; and moving the cover into the closed position to cover the mesh area. When moving the cover into the closed position, one may also position at least a portion of a child restraint in an opening in the cover.

From the foregoing, persons of ordinary skill in the art will appreciate that many modifications of the illustrated strollers and/or methods are possible. For example, the foldable cover 58 may or may not include the padded regions 310 and/or seams 121. As another example, the foldable cover 58 may include additional fasteners such that the foldable cover 58 may be placed in one or more partially opened positions, thereby allowing a finer regulation of the airflow through the mesh panel 56. As yet another example, the seat bottom 42 may also include a mesh panel, and the foldable cover 58 may be extended to cover, either partially or completely, this additional mesh panel. Additionally, one or more additional covers may be used to cover one or more mesh panel(s). Further, although the illustrated seat back 54 includes a mesh panel 56, persons of ordinary skill in the art will appreciate that the entire seat back 54 and/or the entire seat bottom 42 may alternatively be mesh.

Although certain example methods and apparatus have been described herein, the scope of coverage of this patent is not limited thereto. On the contrary, this patent covers all methods and apparatus fairly falling within the scope of the appended claims either literally or under the doctrine of equivalents.

What is claimed is:

1. A stroller comprising:
a wheeled frame;
a seat coupled to the frame, at least a portion of the seat comprising mesh; and
a cover to selectively cover at least a portion of the mesh.

2. A stroller as defined in claim 1 wherein the at least a portion of the seat comprises a seat back and the mesh comprises a mesh panel in the seat back.

3. A stroller as defined in claim 1 wherein the cover is coupled to the seat or the frame.

4. A stroller as defined in claim 1 further comprising a fastener to secure the cover in at least one of a closed position, an on position, or an opened position.

5. A stroller as defined in claim 4 wherein the cover covers the mesh when the cover is in the closed position or the on position, and the cover does not cover at least a portion of the mesh when the cover is in the opened position or an off position.

6. A stroller as defined in claim 4 wherein the fastener comprises a hook-and-loop fastener, a snap, a button, a zipper, glue, or a tie.

7. A stroller as defined in claim 1 wherein the cover is divided into a plurality of sections.

8. A stroller as defined in claim 7 wherein the sections in the plurality of sections are substantially equal in area.

9. A stroller as defined in claim 1 wherein the cover contains padding.

10. A stroller as defined in claim 9 wherein the cover is divided into a plurality of sections.

11. A stroller as defined in claim 10 wherein the cover is divided into a plurality of sections by seams.

12. A stroller as defined in claim 1 wherein the cover is at least one of foldable or rollable into a headrest.

13. A stroller as defined in claim 1 wherein the cover includes an opening to at least partially receive a portion of a child restraint.

14. A stroller as defined in claim 1 further comprising a first fastener on a front surface of the cover and a second fastener on a back surface of the cover, the first and second fasteners cooperating to secure the cover in the opened position.

15. A stroller as defined in claim 14 further comprising a third fastener on the back surface of the cover and a fourth fastener on the seat, the third and fourth fasteners cooperating to secure the cover in the closed position.

16. A stroller as defined in claim 1 further comprising a third fastener on the back surface of the cover and a fourth fastener on the seat, the third and fourth fasteners cooperating to secure the cover in the closed position.

17. A seat for a stroller comprising:
a back support;
a seat bottom;
a mesh panel in the back support or the seat bottom; and
a cover to cover at least a portion of the mesh panel.

18. A seat as defined in claim 17 further comprising a fastener to secure the cover in at least one of a closed position, an on position, or an opened position with respect to the mesh panel.

19. A seat as defined in claim 17 wherein the cover is configurable into a headrest.

20. A method to ventilate a stroller comprising:
moving a cover from a closed position to an opened position to expose at least a portion of a mesh area in a seat; and
securing the cover in the opened position.

21. A method as defined in claim 20 wherein moving the cover comprises shaping the cover into a headrest.

22. A method as defined in claim 20 further comprising:
releasing the cover; and
moving the cover into the closed position to cover the mesh area.

23. A method as defined in claim 22 further comprising positioning at least a portion of a child restraint in an opening in the cover.

24. A method as defined in claim 20 wherein moving the cover comprises folding or rolling the cover.

25. A method as defined in claim 20 wherein the mesh area is located in a seat back of the seat.

26. A method as defined in claim 20 wherein the mesh area is located in a seat bottom of the seat.

27. A method as defined in claim 20 further comprising removing a child restraint from an opening in the cover.

28. A method to ventilate a stroller comprising:
removing a cover from at least a portion of a mesh area in a seat.

29. A stroller comprising:
a wheeled frame;
a seat including a mesh panel; and
a flap having a first configuration and a second configuration, the flap covering the mesh panel in the first configuration and the flap being a headrest in the second configuration.
